(19) United States
(12) Patent Application Publication
(10) Pub. No.: US 2012/0171455 A1
(43) Pub. Date: Jul. 5, 2012

(54) FILLED POLYIMIDES AND METHODS RELATED THERETO

(76) Inventor: Salah Boussaad, Wilmington, DE (US)

(21) Appl. No.: 13/496,524

(22) PCT Filed: Oct. 6, 2010
(86) PCT No.: PCT/US2010/051594

§ 371 Date: Mar. 16, 2012

Related U.S. Application Data
(60) Provisional application No. 61/249,334, filed on Oct. 7, 2009.

(51) Int. Cl. B32B 3/00; C08K 3/04; B32B 7/12; C08L 33/20

(52) U.S. Cl. 428/220; 525/183; 524/495; 428/355 EP

(57) ABSTRACT

The present disclosure relates generally to filled polyimides that can be formed into films, fibers and other articles. The filled polyimide is useful in coverlay applications and has advantageous dielectric, mechanical and optical properties.

### FIELD OF THE DISCLOSURE

The present disclosure relates generally to filled polyimides that can be used in films, fibers and other articles. The filled polyimides of the present disclosure can be useful in electronics applications, such as coverlay films, due to advantageous dielectric and optical properties.

### BACKGROUND INFORMATION

In the electronics industry, a coverlay is generally used as a protective cover film, such as, for flexible printed circuit boards, electronic components or leadframes for integrated circuit packages. The coverlay can prevent damage from scratches, oxidation and contamination. Such coverlays can however be problematic, due to inadequate electrical properties (e.g., dielectric strength), inadequate mechanical strength or inadequate optical properties, such as, for aesthetics or security against unwanted visual inspection and tampering of the electronic components protected by the coverlay.

A need therefore exists for a coverlay having improved mechanical, electrical and/or optical properties.

### SUMMARY

The present disclosure is directed to: i. blends of polyacrylonitrile in a polyimide precursor to create polyimides containing amorphous carbon domains (hereinafter referred to as “filled polyimides”); ii. processes for making such filled polyimides; and iii. articles made from such filled polyimides.

One aspect of this invention is a composition comprising a blend of polyacrylonitrile and polyimide precursor, wherein:

the polyimide precursor is derived from:
i) at least 50 mole percent of an aromatic dianhydride, based upon a total dianhydride content of the polyimide precursor, and
ii) at least 50 mole percent of an aromatic diamine based upon a total diamine content of the polyimide precursor;
   the polyimide precursor forms a continuous phase in the blend;
   the polyacrylonitrile forms domains in a discontinuous phase in the blend;
   the weight ratio of polyacrylonitrile to polyimide precursor is about 1:2 to 1:50; and
   the domain size of the polyacrylonitrile is equal to or less than 2 microns in at least one dimension (and optionally in two dimensions and also optionally in all three dimensions).

Another aspect of this invention is a filled polyimide polymer comprising:
a) a continuous polyimide phase, wherein the polyimide is derived from at least 50 mole percent of an aromatic dianhydride, based upon a total dianhydride content of the polyimide, and at least 50 mole percent of an aromatic diamine based upon a total diamine content of the polyimide;
b) a dispersed carbon phase comprising substantially amorphous carbon domains,
wherein the average carbon domain size is equal to or less than 2 microns; and
the weight ratio of the dispersed carbon phase to the polyimide phase is about 1:2 to 1:50.

Another aspect of this invention is a filled polyimide polymer obtained by:
a) dispersing a first solution comprising polyacrylonitrile (PAN) and a first solvent in a second solution comprising a second solvent and a polyimide precursor to form a PAN/polyimide precursor blend in which the polyimide precursor forms a continuous phase and the PAN forms a discontinuous phase consisting of PAN domains;

wherein:
the polyimide precursor is derived from at least 50 mole percent of an aromatic dianhydride, based upon a total dianhydride content of the polyimide precursor, and at least 50 mole percent of an aromatic diamine based upon a total diamine content of the polyimide precursor;
the weight ratio of PAN to polyimide precursor is about 1:2 to 1:50; and
the average size of the PAN domains is equal to or less than 2 microns in at least one dimension (and optionally in two dimensions and also optionally in all three dimensions); and
b) heating the PAN/polyimide precursor blend to 300-500° C. to convert the PAN domains to substantially amorphous carbon domains and convert the polyimide precursor to polyimide.

Another aspect of this invention is a filled polyimide film obtained by:
a) dispersing a first solution comprising polyacrylonitrile (PAN) and a first solvent in a second solution comprising a second solvent and a polyimide precursor to form a PAN/polyimide precursor blend in which the polyimide precursor forms a continuous phase and the PAN forms a discontinuous phase consisting of PAN domains;

wherein:
the polyimide precursor is derived from at least 50 mole percent of an aromatic dianhydride, based upon a total dianhydride content of the polyimide precursor, and at least 50 mole percent of an aromatic diamine based upon a total diamine content of the polyimide precursor;
the weight ratio of PAN to polyimide precursor is about 1:2 to 1:50;
and the average size of the PAN domains is equal to or less than 2 microns in at least one dimension (and optionally in two dimensions and also optionally in all three dimensions);
b) forming a film from the PAN/polyimide precursor blend; and
c) heating the PAN/polyimide precursor blend film to 300-500° C. to convert the PAN domains to substantially amorphous carbon domains and convert the polyimide precursor to polyimide.

Another aspect of this invention is a coverlay comprising a filled polyimide film and an adhesive coated on at least one side of the film.

Another aspect of this invention is a filled polyimide fiber obtained by:
a) dispersing a first solution comprising polyacrylonitrile

(PAN) and a first solvent in a second solution comprising a second solvent and a polyimide precursor to form a PAN/polyimide precursor blend in which the polyimide precursor forms a continuous phase and the PAN forms a discontinuous phase consisting of PAN domains;

wherein:
the polyimide precursor is derived from at least 50 mole percent of an aromatic dianhydride, based upon a total dianhydride content of the polyimide precursor, and at least 50 mole percent of an aromatic diamine based upon a total diamine content of the polyimide precursor; the weight ratio of PAN to polyimide precursor is about 1:2 to 1:50; and the average size of the PAN domains is equal to or less than 2 microns in at least one dimension (and optionally in two dimensions and also optionally in all three dimensions);
b) forming a fiber from the PAN/polyimide precursor blend; and
c) heating the PAN/polyimide precursor blend fiber to 300-500° C. to convert the PAN domains to substantially amorphous carbon domains and convert the polyimide precursor to polyimide.

### BRIEF DESCRIPTION OF THE FIGURES

FIG. 1 is a graph of optical density in the visible optical density range of films prepared from blends of PAN and PMDA/ODA following conditions of Example 2, and blends of PAN and PPD/BPDA following conditions of Example 3.

FIG. 2 is an SEM cross-section of sample A3.

FIG. 3 is an SEM cross-section of sample C3.

### DETAILED DESCRIPTION

The following discussion is directed to the preferred embodiments of the present invention only, and nothing within the following disclosure is intended to limit the overall scope of this invention. The scope of the present invention is to be defined solely by the claims, as presented at the end of this specification.

### Definitions

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only to those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

“Dianhydride” as used herein is intended to include dianhydrides, precursors or derivatives thereof, which may not technically be a dianhydride but would nevertheless react with a diamine to form a polyamic acid which could in turn be converted into a polyimide.

“Diamine” as used herein is intended to include diamines, precursors or derivatives thereof, which may not technically be a diamine but would nevertheless react with a dianhydride to form a polyamic acid which could in turn be converted into a polyimide.

“Precursor” and “polyamic acid” may be used interchangeably and as used herein is intended to mean a relatively low molecular weight polyamic acid solution which can be prepared by using a stoichiometric excess of diamine to give a solution viscosity of approximately 40-100 Poise.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers, unless the context indicates or implies otherwise.

### Polyamic Acid Solution

A polyamic acid solution is formed from a diamine component and a dianhydride component forming a polyimide precursor in a suitable solvent. Therefore, the polyamic acid solution comprises a polyimide precursor and a solvent. In some embodiments, at least 50 mole percent of an aromatic dianhydride, based upon a total dianhydride content of the polyimide precursor, and at least 50 mole percent of an aromatic diamine based upon a total diamine content of the polyimide precursor. In some embodiments, the aromatic dianhydride is selected from the group consisting of:
pyromellitic dianhydride (PMDA),
3,3′,4,4′-biphenyl tetracarboxylic dianhydride (BPDA),
3,3′,4,4′-benzophenone tetracarboxylic dianhydride (BTDA);
4,4′-oxydiphthalic anhydride,
3,3′,4,4′-diphenyl sulfone tetracarboxylic dianhydride,
2,2-bis(3,4-dicarboxyphenyl) hexafluoropropane,
Bisphenol A dianhydride, and
mixtures thereof.

In some embodiments, the aromatic diamine is selected from the group consisting of:
3,4′-oxydianiline(3,4′-ODA),
1,3-bis-(4-aminophenoxy) benzene (RODA),
4,4′-oxydianiline (4,4′-ODA),
1,4-diaminobenzene(PPD),
1,3-diaminobenzene (MPD),
2,2′-bis(trifluoromethyl) benzidene,
4,4′-diaminobiphenyl,
4,4′-diaminodiphenyl sulfide,
9,9′-bis(4-amino)fluorine and
mixtures thereof.

In another embodiment, the diamine is 1,4-diaminobenzene and the dianhydride is 3,3′,4,4′-biphenyl tetracarboxylic dianhydride. In another embodiment, the diamine is 4,4′-oxydianiline and the dianhydride is pyromellitic dianhydride. In yet another embodiment, the diamine is mixture of 1,4-diaminobenzene and 1,3-diaminobenzene, and the dianhydride is 3,3′,4,4′-biphenyl tetracarboxylic dianhydride.

In some embodiments, the polyimide precursor is derived from: 10 to 90 mole % of biphenyltetracarboxylic dianhydride; 90 to 10 mole % of pyromellitic dianhydride; 10 to 90 mole % of 1,4-diaminobenzene; and 90 to 10 mole % of 4,4′-oxydianiline.

In some embodiments, the diamine component is selected from 1,4-diaminobenzene and 4,4′-oxydianiline. The dianhydride component is selected from pyromellitic dianhydride and 3,3′,4,4′-biphenyl tetracarboxylic dianhydride.

In another embodiment, the diamine is a mixture of 1,4-diaminobenzene PPD and 4,4′-oxydianiline ODA and the dianhydride is a mixture of pyromellitic dianhydride PMDA and 3,3′,4,4′-biphenyl tetracarboxylic dianhydride BPDA. In one embodiment, the polyimide is derived from: 10 to 90 mole %, or 30 to 50 mole %, of biphenyltetracarboxylic dianhydride; 90 to 10 mole %, or 70 to 50 mol %, of pyromellitic dianhydride; 10 to 90 mole %, or 60 to 80 mole %, of 1,4-diaminobenzene; and 90 to 10 mole %, or 40 to 20 mole %, of 4,4′-oxydianiline.

### Solvent

Suitable solvents for forming the polyamic acid solution must be capable of dissolving one or both of the polymerizing reactants and the polyamic acid polymerization product. The solvent should be substantially unreactive with all of the polymerizing reactants and with the polyamic acid polymerization product. Suitable solvents include sulfoxide solvents (e.g., dimethyl sulfoxide and diethyl sulfoxide), formamide solvents (e.g., N,N-dimethylformamide and N,N-diethylformamide), acetamide solvents (e.g., N,N-dimethylacetamide and N,N-diethylacetamide), pyrrolidone solvents (e.g., N-methyl-2-pyrrolidone and N-vinyl-2-pyrrolidone), phenol solvents (e.g., phenol, o-, m- or p-cresol, xylenol, halogenated phenols, and catechol), hexamethylphosphoramide, tetrametyl urea, dimethylsulfone and gamma-butyrolactone. These solvents can also be used in combination with aromatic hydrocarbons such as xylene and toluene, or ether containing solvents such as diglyme, propylene glycol methyl ether, propylene glycol, methyl ether acetate, and tetrahydrofuran.

### Polvamic Acid Solution—Formation

The polyamic acid solutions are generally made by dissolving the diamine in a dry solvent and slowly adding the dianhydride under conditions of agitation and controlled temperature in an inert atmosphere.

In one embodiment the diamine is present as a 5 to 15 weight percent solution in the solvent and the diamine and dianhydride are usually used in about equimolar amounts.

Numerous embodiments of formation are possible, such as: (a) a method wherein the diamine components and dianhydride components are preliminarily mixed together and then the mixture is added in portions to a solvent while stirring, (b) a method wherein a solvent is added to a stirring mixture of diamine and dianhydride components, (c) a method wherein diamines are exclusively dissolved in a solvent and then dianhydrides are added thereto, (d) a method wherein the dianhydride components are exclusively dissolved in a solvent and then amine components are added thereto, (e) a method wherein the diamine components and the dianhydride components are separately dissolved in solvents and then these solutions are mixed in a reactor, (f) a method wherein the polyamic acid with excessive amine component and another polyamic acid with excessive dianhydride component are preliminarily formed and then reacted with each other in a reactor, particularly in such a way as to create a non-random or block copolymer, and (g) a method wherein a specific portion of the amine components and the dianhydride components are first reacted and then the residual diamine components are reacted, or vice versa, (h) a method wherein the components are added in part or in whole in any order to either part or whole of the solvent, also where part or all of any component can be added as a solution in part or all of the solvent, and (i) a method of first reacting one of the dianhydride components with one of the diamine components giving a first polyamic acid, then reacting the other dianhydride component with the other amine component to give a second polyamic acid, and then combining the polyamic acids in any one of a number of ways prior to film or fiber formation.

The dianhydride and diamine components are typically combined in a molar ratio of aromatic dianhydride component to aromatic diamine component of from 0.90 to 1.10. Molecular weight can be adjusted by adjusting the molar ratio of the dianhydride and diamine components.

In one embodiment, the polyamic acid solution is dissolved in an organic solvent at a concentration from about 5, 10 or 12% to about 12, 15, 20, 25, 27, 30% by weight.

If the filled polyimide is to be used as a film, the polyamic acid solution may be combined with conversion chemicals, including: (i) one or more dehydrating agents, such as, aliphatic acid anhydrides (e.g., acetic anhydride) and aromatic acid anhydrides; and (ii) one or more catalysts, such as aliphatic tertiary amines (e.g., triethylamine), aromatic tertiary amines (e.g., dimethylaniline) and heterocyclic tertiary amines (e.g., pyridine, picoline, and isoquinoline). The anhydride dehydrating material is often used in a molar excess of the amount of amide acid groups in the copolyamic acid. The amount of acetic anhydride used is typically about 2.0-3.0 moles per equivalent of copolyamic acid. Generally, a comparable amount of tertiary amine catalyst is used.

### Polyacrylonitrile

For use in this invention, the polyacrylonitrile (PAN) polymer must be dissolved in a solvent, for example dimethylformamide (DMF), N,N-dimethylacetamide (DMAC) or N-methylpyrrolidone (NMP). A solution of PAN can be formed by heating PAN in the selected solvent. Solutions of 5-25 wt % PAN are useful for forming dispersions of PAN in the polyimide precursor.

In some embodiments, polyacrylonitrile is a homopolymer. In another embodiment, polyacrylonitrile is a copolymer with up to 10 mole percent methyl acrylate, vinyl acetate, methacrylic acid, itaconic acid or mixtures thereof. Polyacrylonitrile is commercially available, e.g., from Sigma-Aldrich Chemical Company (St. Louis, Mo., USA).

### Blend Formation

One aspect of this invention is a blend of polyacrylonitrile and a polyimide precursor in which the polyacrylonitrile forms a discontinuous, dispersed phase in a continuous phase of the polyimide precursor. The phases may contain solvents in addition to the polymer and/or precursor.

The blend is formed by mixing a PAN solution and a polyimide precursor solution. For best results, high shear mixing is used, for example, with a planetary centrifugal mixer. The blend comprises PAN and polyimide in a weight ratio of 1:2 to 1:50, or 1:5 to 1:50, or 1:10 to 1:50.

Typically, the average domain size of the PAN phase is 0.1-2 microns, preferably 0.25-0.75 microns, as determined by SEM.

### Formation of the Polymer Blend Film

The blend can be cast or applied onto a support, such as a glass, metal or polymer substrate or an endless belt or rotating drum, to give a film. Next, the solvent-containing film can be converted into a self-supporting film by heating in air or nitrogen at 80 to 200° C. In some embodiments, the film is then separated from the support, oriented such as by tentering, with continued heating (curing) in nitrogen at 300-500° C. to provide a filled polyimide film in which the polyimide precursor has been converted to a polyimide and the PAN has been substantially converted to amorphous carbon. In some embodiments, a cure temperature of 400° C. is used. In other embodiments, the film remains on the support through the curing process.

After curing, the filled polyimide film is highly colored, with the colors ranging from brown to black. More intense colors are achieved using higher ratios of PAN to polyimide precursor and/or by more intense heating during the curing step (i.e., higher temperatures and/or longer times). Thus the color intensity can be fine tuned by adjusting the temperature, cure time or both.

Typically, the cured film is glossy, but a matte finish can be obtained by adding matte agents at any stage of the process prior to casting or by treating the surface of the cured film. Typical matte agents include amorphous silica, such as precipitated silica, fumed silica, diatomaceous silica, and silica gels. Other matte agents include organic polymeric particles (e.g., polyimide powders), inorganic particles, metal stearates, and nanoparticles.

In some embodiments, the optical density (opacity) desirable (e.g., to hide the conductor traces in the flex circuits from view) is greater than or equal to 2. An optical density of 2 is intended to mean 1×10⁻² or 1% of the light is transmitted through the film.

Because the blend contains solvent that must be removed during the drying and converting steps, the cast film generally must be restrained during drying to avoid undesired shrinkage. In continuous production, the film can be held at the edges, such as in a tenter frame, using tenter clips or pins for restraint. Alternatively, the film can be stretched by as much as 200 percent from its initial dimension. In film manufacture, stretching can be in either the longitudinal direction or the transverse direction or both. If desired, restraint can also be provided to permit some limited degree of shrinkage.

High temperatures can be used for short times to dry the film and induce imidization to convert the polyimide precursor to a polyimide in the same step. Generally, less heat and time are required for thin films than for thicker films.

The thickness of the film may be adjusted depending on the intended purpose of the film or final application specifications. It is generally preferred that the thickness of the film ranges from 2, 3, 5, 7, 8, 10, 12, 15, 20, or 25 microns to about 25, 30, 35, 40, 45, 50, 60, 80, 100, 125, 150, 175, 200, 300, 400 or 500 microns. Preferably, the thickness is from about 8 to about 125 microns.

A uniform dispersion of isolated carbon domains not only decreases the electrical conductivity, but additionally tends to produce uniform color intensity. In some embodiments, the mean particle size of the PAN-derived carbon is between (and optionally including) any two of the following sizes: 0.2, 0.3, 0.4, 0.5, 0.6, 0.7, 0.8, 0.9, 1.0, 1.5 and 2.0 microns. The thickness of the film can be tailored to the specific application.

### Formation of the Polymer Blend Fiber

Filled polyimide fibers can also be made from the blend of polyacrylonitrile and polyimide precursor. Fiber can be spun from the blend and then heated to convert the polyimide precursor into a continuous polyimide phase and the polyacrylonitrile into a discontinuous carbon phase. The high temperature imidization/carbonization step can be carried out on the fiber immediately after spinning. Alternatively, the yarn, fabric or article made from the fiber can be heated to the appropriate temperature.

### Coverlay

The filled polyimide film described herein can be used as a coverlay film for flexible printed circuit boards, electronic components or the leadframe of an integrated circuit package.

### Adhesives

In one embodiment, the coverlay film comprises a filled polyimide film and an adhesive layer for maintaining the placement of the coverlay film once applied. Examples of adhesives useful in forming the adhesive layer include thermoplastic polyimide resins, epoxy resins, phenolic resins, melamine resins, acrylic resins, cyanate resins and combinations thereof. In some embodiments, the adhesive is a polyimide resin that can flow and bond at temperatures below the polyimide decomposition temperature. In one embodiment, the adhesive is a polyimide thermoplastic resin, optionally further comprising a thermosetting adhesive, such as, epoxy resin and/or phenolic resin. For adhesives having both thermoplastic and thermosetting components, the content of the thermosetting resin in the adhesive layer generally ranges from 5 to 400 parts by weight, preferably from 50 to 200 parts by weight, per 100 parts by weight of resin components other than the thermosetting resin.

In one embodiment, the adhesive consists of an epoxy resin and hardener, and, optionally, further contains additional components, such as, an elastomer reinforcing agent, curing accelerator, filler and flame retardant.

In some embodiments, the adhesive is an epoxy resin selected from the group consisting of: bisphenol A epoxy resins; bisphenol F epoxy resins; bisphenol S epoxy resins; phenol novolac epoxy resins; cresol novolac epoxy resins; biphenyl epoxy resins; biphenyl aralkyl epoxy resins; aralkyl epoxy resins; dicyclopentadiene epoxy resins; multifunctional epoxy resins; naphthalene epoxy resins; phosphorus containing epoxy resins; rubber modified epoxy resins, and mixtures thereof.

In some embodiments, the epoxy adhesive contains a hardener. Suitable hardeners include phenolic compounds selected from the group consisting of: novolac phenol resins; aralkyl phenol resins; biphenyl aralkyl phenol resins; multifunctional phenol resins; nitrogen-containing phenol resins; dicyclopentadiene phenol resins; and phosphorus-containing phenol resins.

In another embodiment, the hardener is an aromatic diamine compound selected from the group consisting of: diaminobiphenyl compounds, e.g., 4,4′-diaminobiphenyl and 4,4′-diamino-2,2′-dimethylbiphenyl; diaminodiphenylalkane compounds, e.g., 4,4′-diaminodiphenylmethane and 4,4′-diaminodiphenylethane; diaminodiphenyl ether compounds, e.g., 4,4′-diaminodiphenylether and di(4-amino-3-ethylphenyl)ether; diaminodiphenyl thioether compounds, e.g., 4,4′-diaminodiphenyl thioether and di(4-amino-3-propylphenyl)thioether; diaminodiphenyl sulfone compounds, e.g., 4,4′-diaminodiphenyl sulfone and di(4-amino-3-isopropylphenyl)sulfone; and phenylenediamines. In one embodiment, the hardener is an amine compound selected from the group consisting of: guanidines, e.g., dicyandiamide (DICY); and aliphatic diamines, e.g., ethylenediamine and diethylenediamine.

In the following examples all parts and percentages are by weight unless otherwise indicated.

### EXAMPLES

The materials, methods, and examples herein are illustrative only and, except as specifically stated, are not intended to be limiting. Although methods and materials similar or equivalent to those described herein can be used in the practice or testing of the present invention, suitable methods and materials are described herein.

Unless otherwise indicated, all materials were obtained from Sigma-Aldrich Chemical Company, St. Louis, Mo., USA.

Surface glossiness was measured using Horiba Handy Gloss meter (Model: IG-310). Visible optical density was measured with X-rite339 from X-rite (Grand Rapids, Mich. USA).

The PAN-PI blends were mixed using a planetary centrifugal mixer from THINKY (Model: ARE-310).

Dielectric constant and loss tangent were determined by ASTM D-2520: The thickness of a 100 mm×100 mm sample was measured and then the film was placed in a rectangular waveguide cavity. The dielectric constant was measured by the change in frequency of the first six odd-mode resonances (2.2 GHz, 3.4 GHz, 5.0 GHz, 6.8 GHz, 8.6 GHz and 10.4 GHz). Loss tangent was determined by comparing the change in the quality factor at each measured resonance. A Damaskos Model 003 Test Fixture was used in conjunction with an Anritsu 37000 series Vector Network Analyzer.

Volume and Surface Resistivity—ASTM-D-247: A Hewlett Packard 16008A Resistivity Cell was used in conjunction with a Hewlett Packard 4329A High Resistance Meter.

### Example 1

### PAN in H Polymer

Polyacrylonitrile (PAN, 0.92 g) was dissolved in 9.2 g of dimethylformamide (DMF) for 4 hr at 85° C. in a glass jar. The resulting 10 wt % PAN solution was stirred continuously on a hotplate using a magnetic stirrer.

Polyamic acid was prepared using standard methods from pyromellitic dianhydride (PMDA) and 4,4′-oxydiphenylamine (ODA) in a molar ratio of 0.98:1 in DMAC, at 17 wt % solids with a viscosity of about 40-100 poise. To this solution, a freshly prepared solution of 6 wt % PMDA in DMAC was added in small portions to incrementally increase the molecular weight of the polyamic acid. The final viscosity was approximately 477 poise and was used for the preparation of 10 wt % and 37 wt % blends of PAN and PMDA/ODA precursor.

The polymer solutions (39.9 g polyamic acid and 1.082 g of PAN) were combined and mixed at room temperature using a planetary centrifugal mixer for 1 min at 2000 RPM. Films of the polymer blend were cast on 7″×7″ glass plates using a 10 mil BYK-Gardner bar-type applicator and dried in air on a hotplate for 45 min at 90° C. The films were then cured under nitrogen for 20 min at 450° C. The films were black in color.

### Example 2

### PAN in PMDA/ODA

Polyacrylonitrile (0.5069 g) was dissolved in dimethylformamide (9.5 g) for 4 hr at 90° C. in a glass jar. The resulting 5.1 wt % polymer solution was stirred continuously on a hotplate using a magnetic stirrer. This solution was used as the stock solution for the preparation of the several blends of PAN and PMDA/ODA precursor as described in Table 1.

Polyamic acid was prepared using standard methods from PMDA and ODA in a molar ratio of 0.98:1 in DMAC, at 20.6 wt % solids with a viscosity of about 40-100 poise. To this polyamic acid solution, a freshly prepared solution of 6 wt % PMDA in DMAC was added in small portions to incrementally increase the molecular weight of the polymer. The final viscosity was approximately 1500 poise and the 186.1 g of polyamic acid solution was used as stock for the preparation of various blends of PAN and PMDA/ODA precursor, as described in Table 1.

TABLE 1
Preparation of Polyimide/Polyacrylonitrile
Films from PMDA/ODA Polymer

| | Compar- | Compar- | Compar- | Compar- | |
|---|---|---|---|---|---|
| | ative Ex- | ative Ex- | ative Ex- | ative Ex- | Example |
| Sample | ample A | ample B | ample C | ample D | 2 |
| Weight of | 1.082 | 0.506 | 1.919 | 2.07 | 3.54 |
| PAN | | | | | |
| solution (g) | | | | | |
| Weight of | 39.65 | 42.1 | 40.1 | 40.0 | 40.0 |
| PMDA/ODA | | | | | |
| precursor | | | | | |
| solution (g) | | | | | |
| Wt % PAN | 0.72% | 0.32% | 1.26% | 1.36% | 2.31% |
| in polyimide | | | | | |
| blend | | | | | |
| Curing | 350 | 350 | 350 | 400 | 400 |
| Temp (° C.) | | | | | |
| Curing | 10 | 10 | 10 | 15 | 20 |
| Time (min) | | | | | |
| Visible | 1.15 | 0.89 | 1.50 | 1.93 | 2.67 |
| Optical | | | | | |
| Density | | | | | |

Each blend was mixed at room temperature using a planetary centrifugal mixer twice for 30 sec at 2000 RPM. The films made from the various blends of PAN and PMDA/ODA were cast on 7″×7″ glass plates using a 10 mil BYK-Gardner bar-type applicator. The films were dried in air on a hotplate for 45 min at 90° C. and cured under nitrogen as described in Table 1.

The color of the films varied from the natural color of polyimide to dark brown, with darker colors obtained with greater than 2 wt % of PAN, or increasing the curing temperature and/or curing time. Gloss of the cured films decreased with wt % of PAN in PMDA/ODA.

Visible optical density increases with wt % of PAN in PMDA/ODA, with Example 2 having the highest density of 2.6. The difference of 0.43 in visible density between Comparative Example C and Comparative Example D demonstrates that curing films at a high temperature and for a longer period of time leads to more highly colored films.

Example 2 shows no significant change in the dielectric constant, loss tangent or volume resistivity compared to a polyimide film prepared by standard methods. The average dielectric constant was in the range of 3.6 at 2.17 GHz and decreased slightly to 3.5 at 10.4 GHz. The average loss tangent ranged from 0.016 at 2.17 GHz to 0.022 at 10.4 GHz. The volume resistivity was greater than 10¹⁵ (Ω-cm).

### Example 3

### PAN in BPDA/PPD Polymer

Polyacrylonitrile (8.1 g) was dissolved in dimethylformamide (40.55 g) for 3.5 hours at 85° C. in a glass jar. The resulting 19.95 wt % PAN solution was stirred continuously on a hotplate using a magnetic stirrer. This solution was used as the stock solution for the preparation of the various blends of PAN and BPDA/PPD precursor as described in Table 2.

Polyamic acid (48.8 g) was prepared using standard methods from 3,3′,4,4′-biphenyltetracarboxylic acid dianhydride (BPDA) and 1,4-diaminobenzene (PPD) in a molar ratio of 0.98:1 in DMAC, at 17 wt % solids with a viscosity of about 40-100 poise. To this polyamic acid solution, a freshly prepared solution of 6 wt % PMDA in DMAC was added in small portions to incrementally increase the molecular weight of the polymer. The final viscosity was approximately 650 poise and was used as stock for the preparation of various blends of PAN and BPDA/PPD precursor as described in Table 2.

TABLE 2
Preparation of Polyimide/Polyacrylonitrile
Films from BPDA/PPD Polymer

| Sample | A3 | B3 | C3 |
|---|---|---|---|
| Weight of | 1.31 | 2.51 | 4.76 |
| PAN | | | |
| solution (g) | | | |
| Weight of | 17.1 | 16.0 | 15.7 |
| PPD/BPDA | | | |
| precursor | | | |
| solution (g) | | | |
| Wt % PAN in | 7.32% | 13.92% | 23.81% |
| polyimide | | | |
| blend | | | |
| Curing Temp | 450 | 450 | 450 |
| (° C.) | | | |
| Curing Time | 20 | 20 | 20 |
| (min) | | | |
| Visible | 5.29 | 5.32 | 5.22 |
| Optical | | | |
| Density | | | |

Each blend was mixed at room temperature using a planetary centrifugal mixer twice for 30 sec at 2000 RPM. Films made from the various blends of PAN and BPDA/PPD were cast on 7″×7″ glass plates using a 10 mil BYK-Gardner bar-type applicator. The films were dried in air on a hotplate for 45 min at 90° C. and cured under nitrogen as described in Table 2. The films were black in color, flexible and completely opaque.

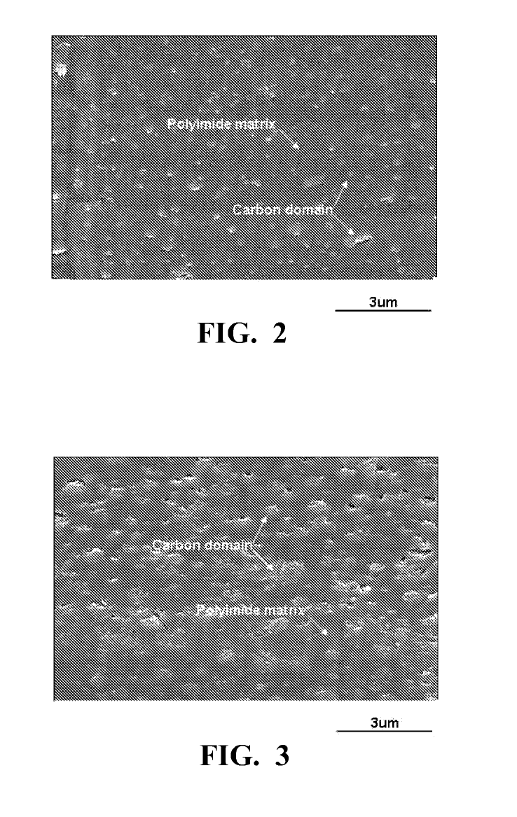

Scanning electron microscopy (SEM) was used to map cured film cross-sections that are perpendicular to the casting direction. The SEM cross-section of Sample A3, shown in FIG. 2, shows a uniform distribution of carbon domains, which are less than about 1 micron wide. Also, a number of voids near or around the carbon domains are visible in the SEM cross-sections. The width of the voids is smaller than the width of the carbon domains. The SEM cross section of Sample C3, shown in FIG. 3, is consistent with the higher wt % of PAN in polyimide in that more carbon domains can be seen in the cross-sections. There are also more voids near or around the carbon domains. The carbon domains in Sample C3 are larger than the domains in Sample A3. A few domains in Sample C3 appear as aggregates of domains. Interestingly, none of the domains formed in Samples A3 or C3 percolate or formed networks, which is consistent with the observation that the dielectric constant, tangent loss and volume resistivity remained unchanged by the presence of PAN in polyimide.

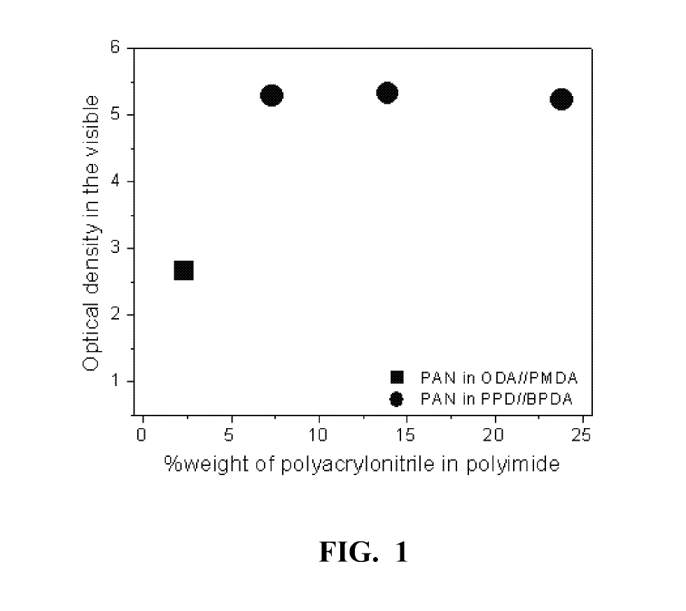

FIG. 1 is a graph of optical density in the visible optical density range of films prepared from blends of PAN and PMDA/ODA following conditions of Example 2, and blends of PAN and BPDA/PPD following conditions of Example 3.

What is claimed is:

1. A composition comprising a blend of polyacrylonitrile and polyimide precursor, wherein:
the polyimide precursor is derived from:
a. at least 50 mole percent of an aromatic dianhydride, based upon a total dianhydride content of the polyimide precurser, and
b. at least 50 mole percent of an aromatic diamine based upon a total diamine content of the polyimide precurser; the polyimide precursor forms a continuous phase in the blend; the polyacrylonitrile forms domains in a discontinuous phase in the blend;
the weight ratio of polyacrylonitrile to polyimide precursor is about 1:2 to 1:50; and
the domain size of the polyacrylonitrile is equal to or less than 2 microns in at least one dimension.

2. The composition of claim 1, wherein
a. the aromatic dianhydride is selected from the group consisting of:
pyromellitic dianhydride,
3,3′,4,4′-biphenyl tetracarboxylic dianhydride,
3,3′,4,4′-benzophenone tetracarboxylic dianhydride;
4,4′-oxydiphthalic anhydride,
3,3′,4,4′-diphenyl sulfone tetracarboxylic dianhydride,
2,2-bis(3,4-dicarboxyphenyl) hexafluoropropane,
Bisphenol A dianhydride, and
mixtures thereof; and
b. the aromatic diamine is selected from the group consisting of:
3,4′-oxydianiline,
1,3-bis-(4-aminophenoxy) benzene,
4,4′-oxydianiline,
1,4-diaminobenzene,
1,3-diaminobenzene,
2,2′-bis(trifluoromethyl) benzidene,
4,4′-diaminobiphenyl,
4,4′-diaminodiphenyl sulfide,
9,9′-bis(4-amino)fluorine and
mixtures thereof.

3. The composition of claim 1, wherein the diamine is 1,4-diaminobenzene and the dianhydride is 3,3′,4,4′-biphenyl tetracarboxylic dianhydride.

4. The composition of claim 1, wherein the diamine is 4,4′-oxydianiline, and the dianhydride is pyromellitic dianhydride.

5. The composition of claim 1, wherein the polyimide precursor is derived from: 10 to 90 mole % of biphenyltetracarboxylic dianhydride; 90 to 10 mole % of pyromellitic dianhydride; 10 to 90 mole % of 1,4-diaminobenzene; and 90 to 10 mole % of 4,4′-oxydianiline.

6. The composition of claim 1, wherein the diamine is mixture of 1,4-diaminobenzene and 1,3-diaminobenzene,and the dianhydride is 3,3′,4,4′-biphenyl tetracarboxylic dianhydride.

7. A filled polyimide polymer comprising:
a) a continuous polyimide phase, wherein the polyimide is derived from
i. at least 50 mole percent of an aromatic dianhydride, based upon a total dianhydride content of the polyimide, and
ii. at least 50 mole percent of an aromatic diamine based upon a total diamine content of the polyimide; and
b) a dispersed carbon phase comprising substantially amorphous carbon domains,
wherein the average carbon domain size is equal to or less than 2 microns in at least one dimension; and
the weight ratio of the dispersed carbon phase to the polyimide phase is 1:10 to 1:50.

8. A filled polyimide polymer obtained by:
a) dispersing a first solution comprising polyacrylonitrile (PAN) and a first solvent in a second solution comprising a second solvent and a polyimide precursor to form a PAN/polyimide precursor blend in which the polyimide precursor forms a continuous phase and the PAN forms a discontinuous phase consisting of PAN domains;
wherein:
the polyimide precursor is derived from at least 50 mole percent of an aromatic dianhydride, based upon a total dianhydride content of the polyimide precursor, and at least 50 mole percent of an aromatic diamine based upon a total diamine content of the polyimide precursor; and
the weight ratio of PAN to polyimide precursor is about 1:2 to 1:50; and
the average size of the PAN domains is equal to or less than 2 microns in at least one dimension; and
b) heating the PAN/polyimide precursor blend to 300-500° C. to convert the PAN domains to substantially amorphous carbon domains and convert the polyimide precursor to polyimide.

9. A filled polyimide film obtained by:
a) dispersing a first solution comprising polyacrylonitrile (PAN) and a first solvent in a second solution comprising a second solvent and a polyimide precursor to form a PAN/polyimide precursor blend in which the polyimide precursor forms a continuous phase and the PAN forms a discontinuous phase consisting of PAN domains; wherein:
the polyimide precursor is derived from at least 50 mole percent of an aromatic dianhydride, based upon a total dianhydride content of the polyimide precursor, and at least 50 mole percent of an aromatic diamine based upon a total diamine content of the polyimide precursor;
the weight ratio of PAN to polyimide precursor is about 1:2 to 1:50; and
the average size of the PAN domains is equal to or less than 2 microns in at least one dimension;
b) forming a film from the PAN/polyimide precursor blend; and
c) heating the PAN/polyimide precursor blend film to 300-500° C. to convert the PAN domains to substantially amorphous carbon domains and convert the polyimide precursor to polyimide.

10. The filled polyimide film of claim 9, wherein the film is 2 to 500 microns in thickness.

11. A coverlay comprising a filled polyimide film of claim 9 and an adhesive coated on at least one side of the film.

12. The coverlay of claim 11, wherein the adhesive is selected from the group consisting of thermoplastic polyimide resins, epoxy resins, phenolic resins, melamine resins, acrylic resins, cyanate resins and combinations thereof.

13. The coverlay of claim 11, wherein the adhesive is a polyimide thermoplastic resin, optionally further comprising a thermosetting adhesive selected from epoxy resins and phenolic resins.

14. The coverlay of claim 11, wherein the adhesive is an epoxy resin selected from the group consisting of: bisphenol A epoxy resins; bisphenol F epoxy resins; bisphenol S epoxy resins; phenol novolac epoxy resins; cresol novolac epoxy resins; biphenyl epoxy resins; biphenyl aralkyl epoxy resins; aralkyl epoxy resins; dicyclopentadiene epoxy resins; multifunctional epoxy resins; naphthalene epoxy resins; phosphorus containing epoxy resins; rubber modified epoxy resins, and mixtures thereof.

15. A filled polyimide fiber obtained by:
a) dispersing a first solution comprising polyacrylonitrile (PAN) and a first solvent in a second solution comprising a second solvent and a polyimide precursor to form a PAN/polyimide precursor blend in which the polyimide precursor forms a continuous phase and the PAN forms a discontinuous phase consisting of PAN domains;
wherein:
the polyimide precursor is derived from at least 50 mole percent of an aromatic dianhydride, based upon a total dianhydride content of the polyimide precursor, and at least 50 mole percent of an aromatic diamine based upon a total diamine content of the polyimide precursor;
the weight ratio of PAN to polyimide precursor is 1:2 to 1:50; and
the average size of the PAN domains is equal to or less than 2 microns in at least one dimension;
b) forming a fiber from the PAN/polyimide precursor blend; and
c) heating the PAN/polyimide precursor blend fiber to 300-500° C. to convert the PAN domains to substantially carbon domains and convert the polyimide precursor to polyimide.
